(19) United States
(12) Patent Application Publication
(10) Pub. No.: US 2008/0243493 A1
(43) Pub. Date: Oct. 2, 2008

(54) Method for Restoring Partials of a Sound Signal

(76) Inventors: Jean-Bernard Rault, Acigne (FR); Mathieu Lagrange, Saint Gilles (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 10/587,097

(22) PCT Filed: Jan. 4, 2005
(86) PCT No.: PCT/FR2005/000019

§ 371 Date: Sep. 24, 2007

(30) Foreign Application Priority Data
Jan. 20, 2004 (FR) 0400619

(51) Int. Cl. G10L 11/04

(52) U.S. Cl. 704/207

(57) ABSTRACT

A method for restoring a partial between a peak Pᵢ and a peak P_{i+N} whose frequency and phase are known. The method (1) comprises the steps of estimating (2) the frequency \hat{ω} of each of the missing peaks Pᵢ₊₁ to P_{i+N-1} of this partial, calculating (3) the phase \hat{φ} from peak to peak, from the phase of the peak Pᵢ to that of the peak P_{i+N}, for all the frequencies \hat{ω} previously estimated, calculating (4) the phase error errφ between the calculated phase \hat{φ} and the known phase at the same peak P_{i+N}, and correcting (5) each calculated phase \hat{φ} by a value that is a function of the phase error errφ.

The present invention relates to the field of telecommunications and in particular to the field of digitally processing a sound signal and to the harmonic representation of a sound signal.

In harmonic modeling of digital audio signals, the sound signal is represented by a set of oscillators whose parameters (frequency, amplitude, phase) vary slowly over time. The harmonic analysis comprises short-term time/frequency analysis for determining the values of these parameters followed by extraction of peaks and then tracking of partials.

The signal to be modeled is divided into frames of l samples (typically l=1024). A short-term time/frequency analysis module (which typically executes a Fourier transform) calculates the short-term spectrum of the signal for each frame. A module for extracting peaks retains only the peaks that are the most pertinent a priori, one criterion being keeping only the highest energy peaks, for example. A third and final module attempts to link the peaks with each other over time, i.e. from one frame to another, to form the partials. During its life cycle each partial corresponds to one oscillator.

That type of analysis and representation may be used in particular during bit rate reduction coding, parametric coding (which processes three aspects of the signal: transients, sinusoids, noise), separation and indexing of sound sources, and restoration of sound files.

It is accepted at present that the best quality is achieved when synthesizing partials by using phase interpolation techniques proposed by Robert J. McAulay and Thomas F. Quatieri in the paper “Speech Analysis/Synthesis Based on a Sinusoidal Representation”, IEEE Transactions on Acoustics, Speech and Signal Processing, pp. 744-754, 1986, or by Laurent Girin, Sylvain Marchand, Joseph di Martino, Axel Röbel and Geoffroy Peeters in the paper “Comparing the order of a Polynomial Phase Model for the Synthesis of Quasi-Harmonic Audio Signals”, WASPAA, New Paltz, N.Y., USA, October 2003. Those techniques are used to synthesize a partial from a peak (Aᵢ, fᵢ, φᵢ) to a peak (Aᵢ₊₁, fᵢ₊₁, φᵢ₊₁) by calculating all the intermediate phases using third or fifth order polynomials, the frequencies being deduced by derivation. Third order interpolation is used when only the start and end frequencies and phases are known. Fifth order interpolation is used when the second order variations of the phase are also known (these are equivalent to first order variations of frequency since by definition frequency is the derivative of phase).

Synthesizing a partial between the peaks Pᵢ(Aᵢ, fᵢ, φᵢ) and Pᵢ₊₁(Aᵢ₊₁, fᵢ₊₁, φᵢ₊₁) consists in calculating the values p(n) of the partial between the frames i and i+1:

pᵢ(n)=p(li+n)=Aᵢ(n)cos(φᵢ(n)),n=0, . . . , l−1 (1)

To this end, it is known in the art to calculate all the intermediate phases using one of the following two interpolation methods.

For third order interpolation according to McAulay, the phase is calculated from the following expression, in which Te is the sampling period:

φᵢ(n)=φᵢ+2πfᵢπTe+α(nTe)²+β(nTe)³ (2)

The two unknowns α and β are calculated by solving a system of equations in (fᵢ, φᵢ, fᵢ₊₁,φᵢ₊₁). The frequencies are deduced by differentiation:

2πfᵢ(n)=2πfᵢ+2αnTe+3β(nTe)² (3)

For fifth order interpolation according to Girin et al., the first order variations δfᵢ and δfᵢ₊₁ of the frequency at the peaks Pᵢ and Pᵢ₊₁ are assumed to be known. The phase is then calculated from the following expression:

$${ϕ}_{i} ( n ) = {ϕ}_{i} + 2 π {f}_{i} nT e + \frac{δ {f}_{i}}{2} {( nTe )}^{2} + {β ( nTe )}^{3} + {γ ( nTe )}^{4} + {δ ( nTe )}^{5} \qquad ( 4 )$$

The three unknowns β, δ, γ are calculated by solving a system of equations in (fᵢ, fᵢ₊₁, φᵢ, φᵢ₊₁, δfᵢ, δfᵢ₊₁). The frequencies are deduced by differentiation:

2πfᵢ(n)=2πfᵢ+δfᵢnTe+3β(nTe)²+4y(nTe)³+5δ(nTe)⁴ (5)

For various reasons, it may happen that certain partials in the signal are absent, corrupted, or discontinuous at the end of analysis and/or at the beginning of synthesis. For example, they may be absent at the input of the decoder in an Internet sound program broadcast application in the event of loss of packets, they may be corrupted if the signal to be analyzed is suffering interference from an unwanted signal (noise, click, other signal, etc.), or they may be discontinuous if their energy is too low for them to be correctly detected continuously. To create a synthesized signal as close as possible to the original signal it is then necessary to restore the missing peaks. This necessitates creating peaks each characterized by an amplitude, a frequency, and a phase.

The above prior art interpolation techniques are used to synthesize the portions corresponding to the missing peaks and to restore the partials.

However, those prior art interpolation techniques are adapted to use in the short-term, i.e. over a period of less than 10 milliseconds (ms). For longer periods, the re-synthesized signal is often very different from the original signal and disagreeable artifacts may appear. Those techniques ensure phase continuity between the existing peaks and the restored peaks but are not able to control the induced frequencies resulting from equations (3) and (5). That effect increases in direct proportion to the interpolation distance.

One object of the invention is to propose an alternative solution to the problem of restoring a missing portion identified as that of a partial, in particular if the missing portion corresponds to a long period (greater than 10 ms), for which the prior art techniques are relatively ineffective.

Accordingly, the technical problem to be solved by the present invention is that of proposing a method of restoring missing portions of partials of a sound signal during harmonic analysis in which the sound signal is divided into time frames to which time/frequency analysis is applied that supplies successive short-term spectra represented by sample frequency frames, the analysis further consisting in extracting spectrum peaks in the frequency frames and linking them together over time to form partials, this method being an alternative to the prior art solutions.

In accordance with the present invention, one solution to the stated technical problem consists in that said method of restoring a partial between a peak Pᵢ and a peak P_{i+N} whose frequency ω and phase are known is characterized in that it comprises the steps of:
estimating the frequency \hat{ω} of each of the missing peaks Pᵢ₊₁ to P_{i+N-1} of this partial;
calculating the phase \hat{φ} from peak to peak, from the phase of the peak Pᵢ to that of the peak P_{i+N}, for all the frequencies \hat{ω} previously estimated;
calculating the phase error errφ between the calculated phase \hat{φ} and the known phase at the same peak P_{i+N};
correcting each calculated phase \hat{φ} by a value that is a function of the phase error errφ.

A method of the invention differs from the prior art methods in that it offers finer control of the frequency of the missing peaks and subsequent calculation of the corresponding phases to ensure continuity with the phases of the existing peaks. Accordingly, a method of the invention re-synthesizes signals corresponding to the missing partial portions without artifacts, in contrast to the prior art methods described above.

A method of the invention also has the advantage of reconstructing a signal that is closer, in terms of the reconstruction error, to the original signal than is the signal obtained by the prior art methods.

Finally, a method of the invention has the advantage of using an algorithm of low complexity.

The invention further consists in a synthesizer for synthesizing a sound signal for implementing a method of restoring a partial between a peak Pᵢ and a peak P_{i+N}, for example an audio decoder or a parametric coder adapted to use a method of the invention.

The invention further consists in a computer program product loadable directly into the internal memory of the above synthesizer or group of synthesizers and comprising software code portions for executing steps of a method according to the invention when the program is executed on the synthesizer or group of synthesizers.

The invention further consists in a medium usable in the above synthesizer or group of synthesizers on which there is stored a computer program product loadable directly into the internal memory of the synthesizer or group of synthesizers and comprising software code portions for executing steps of a method according to the invention when the program is executed on the synthesizer or group of synthesizers.

Other features and advantages of the invention become apparent in the course of the following description, which is given with reference to the appended drawing, which is provided by way of non-limiting example.

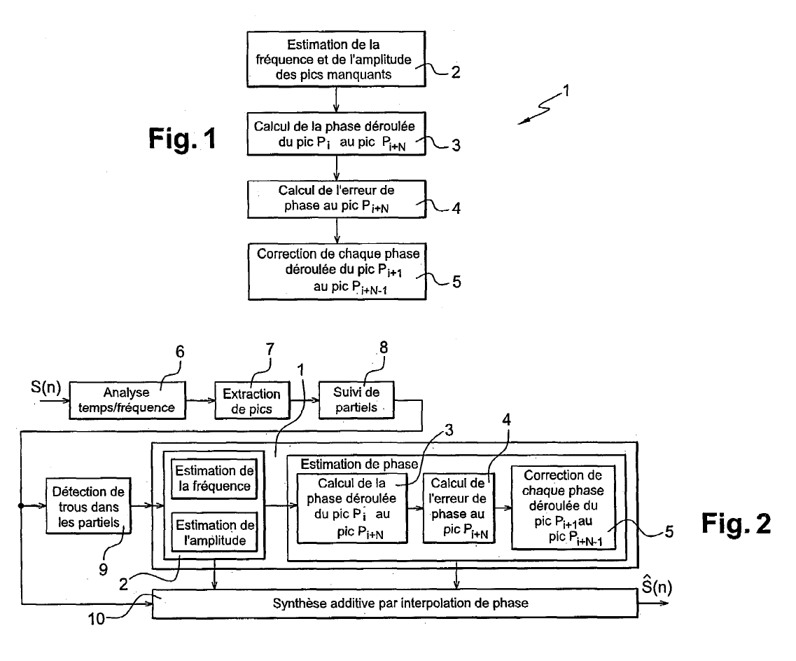

FIG. 1 is a flowchart of one example of the invention.

FIG. 2 is a diagram of one example of the use of a method of the invention.

A method 1 of the invention proceeds in the following manner, described here with reference to the FIG. 1 flowchart. The method consists in restoring a partial between a peak Pᵢ and a peak P_{i+N} whose frequencies ω and phases φ are known.

In a first step 2, the method estimates the frequency \hat{ω} and the amplitude A of each of the missing peaks Pᵢ₊₁ to P_{i+N-1}, for example by linear prediction or interpolation methods known in the art.

Consider a partial consisting of a succession of linked peaks Pᵢ(Aᵢ, ωᵢ, φᵢ) known at times iT and characterized by:

Aᵢ, the amplitude of the peak at the time iT;

ωᵢ, the frequency of the peak at the time iT; and

φᵢ, the phase of the peak at the time iT, modulo 2π.

The frequency of the missing peaks between the peaks Pᵢ and P_{i+N} is estimated by means of linear interpolation between ωᵢ and ω_{i+N}, for example, or linear past or future prediction, as described in the paper “Enhanced Partial Tracking using linear Prediction”, Mathieu Lagrange, Sylvain Marchand, Martin Raspaud and Jean-Bernard Rault, Proceedings of the Digital Audio Effects (DAFX) Conference, pp 141-146, Queen Mary College, University of London, UK, September 2003, for example, or by means of a weighted past or future combination.

The amplitude A of the missing peaks is estimated by linear interpolation between Aᵢ and A_{i+N}, for example, linear past or future prediction, or weighted past or future combination.

In a second step 3, the method calculates the phase \hat{φ} from peak to peak, from the phase of the peak Pᵢ to that of the peak P_{i+N}. This calculation is effected for each of the frequencies a) previously estimated.

Let φᵢ and ωᵢ be the starting phase and frequency and {\hat{ω}ᵢ₊₁, . . . , \hat{ω}_{i+N-1}} estimated frequencies in the range to be reconstructed. To extend the partial between the peak Pᵢ and the peak P_{i+N} the phase is calculated from the following expression:

$${\hat{ϕ}}_{i + n} = mod ( {ϕ}_{i} + {\sum }_{j = 1}^{n} \frac{{\hat{ω}}_{i + j} + {\hat{ω}}_{i + j - 1}}{2} T , 2 π ) , n = 1 , … , N \qquad ( 6 )$$

To avoid generating discontinuities that would compromise the quality of the re-synthesis, it is necessary to obtain at the time i+N a reconstructed phase \hat{φ}_{i+N} equal to φ_{i+N}. The data in the above expression (6) being either approximate or predicted, it is statistically impossible to obtain this equality. Consequently, the subsequent steps of the method divide the phase error errφ calculated at the time i+N between all the missing peaks Pᵢ₊₁ to P_{i+N-1} previously reconstructed.

In a third step 4, the method calculates the phase error errφ between the calculated phase \hat{φ}_{i+N} and the known phase φ_{i+N} at the same peak P_{i+N}. This calculation may use the following system of equations:

if |φ_{i+N}−\hat{φ}_{i+N}+2π|<|φ_{i+N}−\hat{φ}_{i+N}|,errφ=φ_{i+N}−\hat{φ}_{i+N}+2π (7)

if |φ_{i+N}−\hat{φ}_{i+N}−2π|<|φ_{i+N}−\hat{φ}_{i+N}|,errφ=φ_{i+N}−\hat{φ}_{i+N}−2π (8)

else errφ=φ_{i+N}−\hat{φ}_{i+N} (9)

In a fourth step 5, the method corrects each calculated phase \hat{φ}ᵢ₊ₙ by a value that is a function of the phase error errφ. The phase error calculated at the time i+N is typically divided uniformly between the calculated phases in accordance with the following expression:

$$\hat{ϕ} {corrected}_{i + n} = mod ( {\hat{ϕ}}_{i + n} + err ϕ \frac{n}{N} , 2 π ) n = 1 , … , N - 1 \qquad ( 10 )$$

The distribution need not be uniform, and may conform to a non-linear law, for example.

The FIG. 2 example of use consists in restoring partials by means of the method 1 of the invention at the time of harmonic analysis of a sound signal, for example during parametric coding. The sound signal s(n) is represented by a set of oscillators whose parameters (frequency, amplitude) vary slowly over time. In the conventional way, the harmonic analysis includes short-term time/frequency analysis 6 for determining the values of these parameters, followed by extraction of peaks 7 followed by tracking 8 of partials. Detection 9 of gaps in the partials precedes restoring partials by the method 1 of the invention. The peaks Pᵢ₊ₙ(Âᵢ₊ₙ, \hat{ω}ᵢ₊ₙ, \hat{φ}ᵢ₊ₙ) reconstructed by executing the method 1 are then treated as peaks resulting from the harmonic analysis and additive synthesis 10 of the signal corresponding to the partial restored from these reconstructed peaks may be effected by one of the prior art (third or fifth order) phase interpolation methods, for example.

1. A method of restoring partials of a sound signal during harmonic analysis in which the sound signal is divided into time frames to which time/frequency analysis is applied that supplies successive short-term spectra represented by sample frequency frames, the analysis further including extracting spectrum peaks in the frequency frames and linking them together over time to form partials, wherein the method of restoring a partial between a peak Pᵢ and a peak P_{i+N} whose frequency and phase are known comprises the steps of:
estimating (2) the frequency \hat{ω} of each of the missing peaks Pᵢ₊₁ to P_{i+N-1} of this partial;
calculating (3) the phase \hat{φ} from peak to peak, from the phase of the peak Pᵢ to that of the peak P_{i+N}, for all the frequencies \hat{ω} previously estimated;
calculating (4) the phase error errφ between the calculated phase \hat{φ} and the known phase at the same peak P_{i+N}; and
correcting (5) each calculated phase \hat{φ} by a value that is a function of the phase error errφ.

2. The method according to claim 1, wherein the phase \hat{φ} is calculated from the following formula, in which φᵢ and \hat{ω}ᵢ=ωᵢ are the phase and the frequency of the peak Pᵢ and φ_{i+N} and \hat{ω}_{i+N}=ω_{i+N} are the phase and the frequency of the peak P_{i+N}:
$${\hat{ϕ}}_{i + n} = mod ( {ϕ}_{i} + {\sum }_{j = 1}^{n} \frac{{\hat{ω}}_{i + j} + {\hat{ω}}_{i + j - 1}}{2} T , 2 π ) , n = 1 , … , N \qquad$$

3. A The method according to claim 1 for restoring partials of a sound signal, wherein the frequency \hat{ω} of the missing peaks Pᵢ₊₁ to P_{i+N-1} is estimated by linear interpolation between the frequencies of the known peaks Pᵢ and P_{i+N}.

4. A The method according to claim 1 for restoring partials of a sound signal, wherein the frequency \hat{ω} of the missing peaks Pᵢ₊₁ to P_{i+N-1} is estimated by linear past prediction.

5. The method according to claim 1 for restoring partials of a sound signal, wherein the frequency \hat{ω} of the missing peaks Pᵢ₊₁ to P_{i+N-1} is estimated by linear future prediction.

6. The method according to claim 1 for restoring partials of a sound signal, wherein the frequency \hat{ω} of the missing peaks Pᵢ₊₁ to P_{i+N-1} is estimated by weighted combination of linear past prediction and linear future prediction.

7. The method according to claim 1 for restoring partials of a sound signal, further comprising the step of estimating the amplitude of each of the missing peaks Pᵢ₊₁ to P_{i+N-1} of the partial by linear interpolation between the amplitudes A of the known peaks Pᵢ and P_{i+N}.

8. The method according to claim 1 for restoring partials of a sound signal, further comprising the step of estimating the amplitude of each of the missing peaks Pᵢ₊₁ to P_{i+N-1} of the partial by linear past prediction.

9. The method according to claim 1 for restoring partials of a sound signal, further comprising the step of estimating the amplitude of each of the missing peaks Pᵢ₊₁ to P_{i+N-1} of the partial by linear future prediction.

10. The method according to claim 1 for restoring partials of a sound signal, further comprising the step of estimating the amplitude of each of the missing peaks Pᵢ₊₁ to P_{i+N-1} of the partial by linear past prediction and linear future prediction.

11. The method according to claim 1 for restoring partials of a sound signal, wherein the phase correction consists in distributing the phase error errφ calculated at the time i+N uniformly between all the missing peaks Pᵢ₊₁ to P_{i+N-1} of the partial.

12. The method according to claim 11 for restoring partials of a sound signal, wherein the phase correction is determined by the equation:
$$\hat{ϕ} {corrected}_{i + n} = mod ( {\hat{ϕ}}_{i + n} + err ϕ \frac{n}{N} , 2 π ) n = 1 , … , N - 1$$

13. The method according to claim 12 for restoring partials of a sound signal, wherein the phase correction is determined using the system of equations:
if |φ_{i+N}−\hat{φ}_{i+N}+2π|<|φ_{i+N}−\hat{φ}_{i+N}|,errφ=φ_{i+N}−\hat{φ}_{i+N}+2π,
if |φ_{i+N}−\hat{φ}_{i+N}−2π|<|φ_{i+N}−\hat{φ}_{i+N}|,errφ=φ_{i+N}−\hat{φ}_{i+N}−2π,
else errφ=φ_{i+N}−\hat{φ}_{i+N}.

14. A sound signal synthesizer for implementing the method according to claim 1, comprising:
means for estimating the frequency \hat{ω} of each of the missing peaks Pᵢ₊₁ to P_{i+N-1} of the partial;
means for calculating the phase \hat{φ} from peak to peak, from the phase of the peak Pᵢ to that of the peak P_{i+N}, for all the frequencies \hat{ω} previously estimated;
means for calculating the phase error errφ between the calculated phase \hat{φ} and the known phase at the same peak P_{i+N}; and
means for correcting each calculated phase \hat{φ} by a value that is a function of the phase error errφ.

15. A computer program product loadable directly into the internal memory of a synthesizer, wherein the synthesizer comprises means for estimating the frequency \hat{ω} of each of the missing peaks Pᵢ₊₁ to P_{i+N-1} of the partial;
means for calculating the phase \hat{φ} from peak to peak, from the phase of the peak Pᵢ to that of the peak P_{i+N}, for all the frequencies \hat{ω} previously estimated;
means for calculating the phase error errφ between the calculated phase \hat{φ} and the known phase at the same peak P_{i+N}; and
means for correcting each calculated phase \hat{φ} by a value that is a function of the phase error errφ; and
wherein the computer program product comprises software code portions for executing steps of the method according to claim 1 when the program is executed on the synthesizer.

16. A medium usable in a synthesizer on which there is stored a computer program product loadable directly into an internal memory of the synthesizer wherein the synthesizer comprises:
means for estimating the frequency \hat{ω} of each of the missing peaks Pᵢ₊₁ to P_{i+N-1} of the partial.
means for calculating the phase \hat{φ} from peak to peak, from the phase of the peak Pᵢ to that of the peak P_{i+N}, for all the frequencies \hat{ω} previously estimated;
means for calculating the phase error errφ between the calculated phase \hat{φ} and the known phase at the same peak P_{i+N}; and
means for correcting each calculated phase \hat{φ} by a value that is a function of the phase error errφ; and
wherein the computer program product comprises software code portions for executing steps of the method according to claim 1 when the program is executed on the synthesizer.
